(19) United States
(12) Patent Application Publication
(10) Pub. No.: US 2024/0093582 A1
(43) Pub. Date: Mar. 21, 2024

(54) Oilfield Applications Using Hydrogen Power

(71) Applicant: Halliburton Energy Services, Inc., Houston, TX (US)

(72) Inventors: Glenn Howard WEIGHTMAN, Houston, TX (US); Adam Lynn MARKS, Houston, TX (US); Timothy Holiman HUNTER, Houston, TX (US); Philip D. NGUYEN, Houston, TX (US); Stanley Vernon STEPHENSON, Houston, TX (US)

(21) Appl. No.: 17/948,727

(22) Filed: Sep. 20, 2022

(51) Int. Cl. E21B 41/00; E21B 43/26

(52) U.S. Cl. CPC E21B 41/0085; E21B 43/2607

(57) ABSTRACT

A method includes operating a wellsite apparatus at a wellsite utilizing mechanical energy or electricity produced at least in part from hydrogen in a fuel source comprising hydrogen. Utilizing mechanical energy or electricity produced at least in part from the hydrogen in the fuel source comprising hydrogen can further include: (a) converting the hydrogen in the fuel source to electricity in one or more fuel cells and utilizing the electricity to operate the wellsite apparatus; and/or (b) combusting the hydrogen in the fuel source in a power generation apparatus to produce electricity and utilizing the electricity to operate the wellsite apparatus; and/or (c) combusting the hydrogen in the fuel source to produce mechanical energy and utilizing the mechanical energy to operate the wellsite apparatus. A system for carrying out the method is also provided.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The present disclosure relates generally to wellsite operations. More specifically, the present disclosure relates to systems and methods for powering wellsite apparatus. Still more specifically, the present disclosure relates to systems and methods for powering wellsite apparatus at least in part with hydrogen.

### BACKGROUND

Oilfield operations utilize energy. Conventional combustion of fuels, such as methane and diesel, to meet such energy needs can produce unwanted products, such as carbon dioxide (CO₂) and nitrogen oxides (NOx), which must to be addressed in order to meet ever more restrictive regulations.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic of a method, according to embodiments of this disclosure;

FIG. 2 is a schematic of a generic system, according to embodiments of this disclosure; and

FIG. 3 is a schematic of an exemplary system, according to embodiments of this disclosure.

### DETAILED DESCRIPTION

It should be understood at the outset that although an illustrative implementation of one or more embodiments are provided below, the disclosed systems and/or methods can be implemented using any number of techniques, whether currently known or in existence. The disclosure should in no way be limited to the illustrative implementations, drawings, and techniques below, including the exemplary designs and implementations illustrated and described herein, but can be modified within the scope of the appended claims along with their full scope of equivalents.

Oilfield operations utilize energy. The requisite energy is generally derived from a fuel used in an engine or from an electrical distribution line which also requires an energy source, perhaps a fuel. The combustion of fuels typically produces greenhouse gases (GHGs) which primarily comprise molecules containing carbon (e.g., carbon dioxide (CO₂) and carbon monoxide (CO)). The combustion of hydrogen, however, produces no carbon emissions, since carbon is not a part of the reaction. Accordingly, utilizing hydrogen as a fuel, as described herein, can be desirable for many reasons, including a potential reduction in the production of GHGs.

Combusting hydrogen in air can produce high levels of nitrogen oxides (NOx), thus combusting hydrogen in air can be utilized, in embodiments, along with the use of apparatus, such as catalytic converters or other apparatus, to reduce the NOx to acceptable levels. Combusting hydrogen in pure oxygen produces only water and heat as byproducts. The utilization of fuel cells to produce electricity from hydrogen, as described in embodiments hereinbelow, can be particularly useful, as the use of the hydrogen in fuel cells to produce electricity yields no NOx, thus obviating the need for NOx removal apparatus.

Combusting hydrogen in a dual or tri-fuel scenario (e.g., combusting hydrogen in a fuel comprising one other fuel component (e.g., in a dual fuel) or two other fuel components (e.g., in a tri-fuel) can produce more NOx emissions than combusting a fuel comprising hydrogen as the sole fuel source. For example, combusting hydrogen along with methane can produce up to six times the NOx as combusting methane alone. Accordingly, in embodiments, the fuel source consists essentially of hydrogen, while, in other embodiments, the fuel source comprises a bi-fuel or a tri-fuel, and NOx removal apparatus can be utilized to remove NOx produced during combustion of the fuel.

Disclosed herein are systems and methods for utilizing hydrogen as an energy source at a wellsite, which systems and methods can be particularly useful for hydraulic fracturing applications. Although exemplary applications, such as hydraulic fracturing applications, in which hydrogen is utilized as a fuel source are described hereinbelow, other applications will be apparent to one of skill in the art upon reading this disclosure, some of which will be noted hereinbelow by way of non-limiting examples.

This disclosure describes the use of hydrogen as a fuel source at the wellsite. Via this disclosure, hydrogen (H₂) can be burned (e.g., combusted) or used in a fuel cell to produce electricity. In theory, virtually any application that employs an internal combustion engine or generator (reciprocating or turbine) can use an engine utilizing hydrogen as a fuel as described herein. Likewise, any oilfield application that utilizes electricity can be adapted, as described herein, to utilize electricity produced from a hydrogen fuel cell. In embodiments, as described herein, H₂ can be combined e.g., blended) with existing fuel (e.g., natural gas) infrastructure to reduce logistics and transportation/delivery of traditional mobile fuels.

As per this disclosure, a fuel source can comprise hydrogen in whole or in part. That is, hydrogen can be the sole fuel in the fuel source, or can be used in combination with one or more additional fuel components, for example in a bi-fuel comprising hydrogen and one other fuel component, or in a tri-fuel comprising hydrogen and two other fuel components. Accordingly, reference to the use of 112 as a fuel can indicate the use of hydrogen, in whole or in part, as fuel.

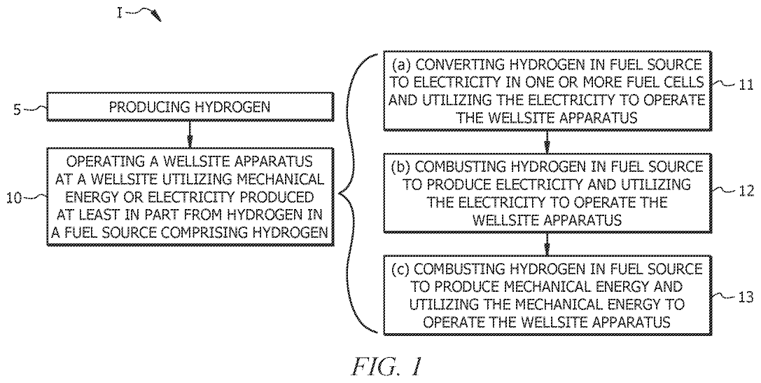

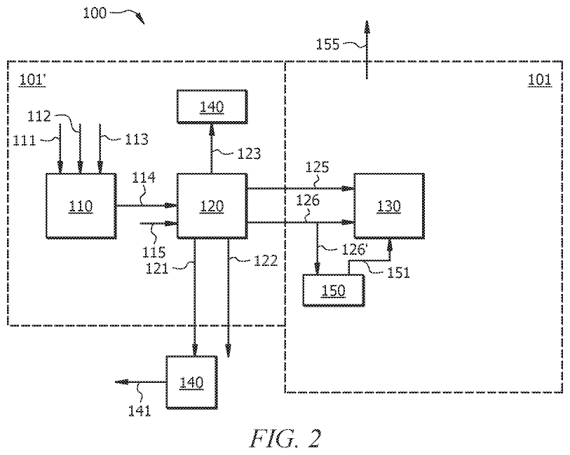

The system and method of this disclosure will now be described with reference to FIG. 1, which is a schematic of a method I, according to embodiments of this disclosure, and FIG. 2, which is a schematic of a generic system 100, according to embodiments of this disclosure. With reference to FIG. 1, method I comprises: as indicated at 10, operating a wellsite apparatus at a wellsite utilizing mechanical energy or electricity produced at least in part from hydrogen in a fuel source comprising hydrogen. Utilizing mechanical energy or electricity produced at least in part from the hydrogen in the fuel source comprising hydrogen, at 10, can comprise electrochemically converting the hydrogen in the fuel source comprising hydrogen, or combusting the hydrogen in the fuel source comprising hydrogen. For example, utilizing mechanical energy or electricity produced at least in part from the hydrogen in the fuel source comprising hydrogen, at 10, can comprise: (a) converting the hydrogen in the fuel source to electricity in one or more fuel cells and utilizing the electricity to operate the wellsite apparatus, as indicated at 11; (b) combusting the hydrogen in the fuel source in a power generation apparatus to produce electricity and utilizing the electricity to operate the wellsite apparatus, as indicated at 12; and/or (c) combusting the hydrogen in the fuel source to produce mechanical energy, and utilizing the mechanical energy to operate the wellsite apparatus, as indicated at 13.

With reference to FIG. 2, a system 100 for carrying out an operation at a wellsite 101 as per this disclosure can comprise: a wellsite apparatus 130 at the wellsite 101; and an apparatus 120 (also referred to herein as a “prime mover”) configured to power the wellsite apparatus 130. The apparatus 120 comprises apparatus for producing mechanical energy, indicated at 125, or electricity, indicated at 126, for powering the wellsite apparatus 130. The apparatus 120 is operable to produce mechanical energy 125 or electricity 126 for powering the wellsite apparatus 130, wherein the mechanical energy 125 or electricity 126 is produced at least in part from hydrogen 111 in a fuel source 110 comprising hydrogen 111. Fuel 114 comprising hydrogen is introduced into the apparatus 120 for producing mechanical energy or electricity. In applications, the wellsite apparatus 130 is electric-driven (e.g., comprises an electric motor), in which applications the apparatus for producing mechanical energy or electricity can comprise apparatus 120 for producing electricity. For example, such apparatus 120 for producing electricity 126 can consist or comprise part of a power (e.g., electricity) generation system that produces electricity for the electric motor. In embodiments, the apparatus for producing electricity 120 comprises one or more fuel cells. In embodiments, the apparatus for producing mechanical energy or electricity 120 comprises hydrogen combustion apparatus. For example, the apparatus for producing mechanical energy or electricity 120 can comprise an engine, such as an internal combustion engine or a reciprocating engine.

In embodiments wherein method I comprises combusting the hydrogen in the fuel 114 comprising hydrogen (e.g., comprising (b) combusting the hydrogen 111 in the fuel source 110 (e.g., in a power generation apparatus of apparatus 120) to produce electricity 126 and utilizing the electricity 126 to operate the wellsite apparatus 130, as indicated at 12; and/or (c) combusting the hydrogen 111 in the fuel 114 comprising hydrogen 111 to produce mechanical energy 125, and utilizing the mechanical energy 125 to operate the wellsite apparatus, as indicated at 13), the method I can further comprise removing nitrogen oxides (NOx) 140 from an exhaust 123 (e.g., an exhaust gas comprising NOx) produced by the combusting of the hydrogen 111 in the apparatus 120 for producing mechanical apparatus or electricity. In applications, combusting of the hydrogen in the fuel 114 comprising hydrogen 111 can be effected in a turbine generator and/or a reciprocating engine generator. In such applications, apparatus 120 for producing mechanical energy or electricity can comprise a generator, such as a turbine generator or a reciprocating engine generator.

In embodiments, the apparatus 120 can be or comprise the same apparatus as wellsite apparatus 130, but depicted separately for clarity of description. For example, apparatus 120 and/or wellsite apparatus 130 can comprise an electric motor or a combustion engine.

The apparatus 120 for producing mechanical energy 125 or electricity 126 can be located at the wellsite 101 at which the wellsite apparatus 120 is located, or can be located at another location 101′. For example, when apparatus 120 comprises one or more fuel cells, the one or more fuel cells can be located at the wellsite 101 or can be located offsite, at another location 101′. The hydrogen 111 utilized in the fuel source 110, the fuel source 114 comprising hydrogen 111, or both can be located at one or more locations 101′ disparate from wellsite 101, in applications. For example, hydrogen 111 can be produced at a first location and transported (e.g., by rail, pipeline, or truck) to another location 101′ at which apparatus 120 is located (e.g., which may or may not be wellsite 101). Alternatively, hydrogen 111 can be produced and/or utilized in apparatus 120 to produce mechanical energy 125 or electricity 126 at wellsite 101.

In embodiments, apparatus 120 comprises an apparatus 120 for producing electricity 126. In some such applications, system 100 can further include an inverter 150 for transforming the DC electricity 126′ from DC to AC electricity 151 for use in wellsite apparatus 130. Alternatively, wellsite apparatus 130 can be configured or re-configured/adapted for DC operation. Accordingly, in embodiments, method I further comprises utilizing an inverter 150 to provide AC electricity 151 for the wellsite apparatus 130. In such embodiments, the wellsite apparatus 130 can comprise an AC motor.

In embodiments, producing mechanical energy or electricity 126 in apparatus 120 produces by-products. For example, as noted above, in embodiments in which apparatus 120 comprises apparatus for combusting the hydrogen 111 in hydrogen fuel 114, an exhaust 123 comprising NOx can be produced as a by-product. In such embodiments, the method I can further include removing NOx from the exhaust 123. For example, system 100 of this disclosure can include a NOx removal apparatus 140 for removing NOx from the exhaust 123. In alternative or additional embodiments, apparatus 120 comprises one or more fuel cells configured for electrochemical conversion of hydrogen 111 in fuel 114 comprising hydrogen 111 to produce electricity 126, and byproducts including substantially pure water 121 and heat 122 can be concomitantly produced. In such embodiments, method I can further comprise utilizing the substantially pure water 121 and/or the heat 122 at the wellsite 101 or at another location 101′. For example, and without limitation, utilizing the substantially pure water 121 at the wellsite 101 can comprise utilizing the substantially pure water 121 to produce a wellbore treatment fluid (e.g., a fracturing fluid) 141. A mixer 140 can be included in system 100 for combining the substantially pure water 121 with one or more additional components to produce the wellbore treatment fluid 141. The substantially pure water 121 can comprise, for example, from about 150 to about 300, from about 150 to about 250, from about 100 to about 300, or less than or equal to about 300, 200, 100, 90, 80, 70, 60, 50, 40, 30, 20, 10 5, or 1 ppm TDS. In embodiments, substantially pure water 121 comprises less than 10, 9, 8, 7, 6, 5, 4, 3, 2, or 1 weight percent (wt %) non-water components (e.g., comprises at least 91, 92, 93, 94, 95, 96, 97, 98, or 99 wt % water). Alternatively or additionally, the substantially pure water 121 can be utilized (e.g., directly) for a variety of other applications, such as, for example, drinking water. In embodiments, one or more process contaminants are removed prior to use.

In embodiments. Method I further comprises producing at least a portion of the hydrogen 111 in the fuel source 110 at the wellsite 101 or another location, as indicated at 5 of FIG. 1. For example, the hydrogen 111 can be produced at wellsite 101, can be produced the location 101′ at which apparatus 120 is located (e.g., at wellsite 101 or another location 101′), or another location disparate from wellsite 101 and the location 101′ of apparatus 120. That is hydrogen 111 can be produced at a same or different location from the location at which the hydrogen 111 is utilized to produce mechanical energy 125 or electricity 126 in apparatus 120, and at a same or different location from wellsite 100 at which wellsite apparatus 130 is powered by mechanical energy 125 or electricity 126 produced in apparatus 120. By way of example, in embodiments, utilizing mechanical energy 125 or electricity 126 produced at least in part from hydrogen 111 in the fuel source 110 comprising hydrogen 111 comprises utilizing electricity 126 produced at least in part from hydrogen 111 in the fuel source 110 comprising hydrogen 111, and producing the electricity 126 at the wellsite 101 and/or at another location 101′ and routing it to the wellsite 101. In such embodiments, the wellsite apparatus 130 can be a component of an electric hydraulic fracturing system at the wellsite 101. Such an electric hydraulic fracturing system can comprise a combination of electrically powered pumps, blending equipment, monitoring vans, sand handling equipment, wireline equipment, etc. In embodiments, the hydrogen 111 is produced at a remote location and transported (e.g., by rail, pipe, truck) to a location at which apparatus 120 is located or to wellsite 101. The location at which apparatus 120 is located and the wellsite can be the same or different.

Via the system and method of this disclosure, carbon dioxide (CO₂) emissions 155 at wellsite 101 can be reduced relative to conventional operations. For example, in embodiments, operating wellsite apparatus 130 with mechanical energy 125 or electricity 126 produced at least in part from hydrogen 111 in fuel source 110 comprising hydrogen 111, rather than from conventional fuels (e.g., diesel, methane, etc.) can reduce CO₂ emissions 155 by at least 5, 10, 20, 30, 40, 50, 60, 70, 80, 90% or more relative to methods and systems not utilizing hydrogen 111 in a fuel 114 as described herein. In embodiments, CO₂ emissions 155 at wellsite 101 are less than or equal to about 150 tons/day, whereas conventional operation produces greater than about 150 tons/day of CO₂ emissions. By reducing an amount of CO₂ produced, the herein disclosed system and method can allow for reduction and/or elimination of equipment conventionally utilized to extract and recover produced CO₂ for safe disposal thereof.

Fuel source 110 and fuel 114 can comprise a dual fuel comprising the hydrogen 111 and another fuel (e.g., second fuel component 112), or a tri-fuel comprising the hydrogen 111 and two other fuels (e.g., second fuel component 112 and third fuel component 113). In embodiments, second fuel component 112 comprises methane or diesel, or second fuel component 112 comprises methane and third fuel component 113 comprises diesel. In embodiments, hydrogen 111 is utilized to at least partially replace a conventional fuel, such as methane or diesel.

As noted hereinabove, the method I and system 100 of this disclosure can be utilized in a wide range of wellbore servicing operations. For example, and as detailed further hereinbelow, in embodiments, the operation is selected from hydraulic fracturing operations, pump down operations, coiled tubing operations, wireline operations, nitrogen operations, ancillary support operations, production operations, transporting (e.g., trucking) operations, power generation operations, acidizing operations, drilling operations, pipeline servicing operations, pumping (e.g., pressure pumping), blending (e.g., mixing components of a treatment fluid, such as a fracturing fluid), or combinations thereof.

In embodiments, a method of performing an operation at a wellsite 101 comprises utilizing hydrogen 111 as a fuel source 110 for a prime mover or apparatus 120 for producing mechanical energy 125 or electricity 126) for powering a wellsite apparatus 130, wherein the wellsite apparatus 130 is utilized in performing the operation at the wellsite 101. As noted previously, by way of example, the operation can be selected from hydraulic fracturing operations, pump down operations, coiled tubing operations, wireline operations, nitrogen operations, ancillary support operations, production operations, transporting (e.g., trucking) operations, power generation operations, acidizing operations, drilling operations, pipeline servicing operations, or combinations thereof. The wellsite apparatus 130 can be electric-driven (e.g., can comprise an electric motor). In such applications, the apparatus 120 can be part of or comprise a power (e.g., electricity) generation system. Alternatively or additionally, the apparatus 120 can comprise one or more fuel cells for producing electricity 126 via electrochemical conversion of the chemical energy in the fuel 114 comprising hydrogen 111 and an oxidant/oxidizing agent 115 (e.g., air, oxygen, substantially pure oxygen) into electricity 126 via paired redox reactions.

In embodiments, apparatus 120 for producing mechanical energy 125 or electricity 126 comprises combustion apparatus operable to combust the fuel 114 comprising hydrogen 11. In embodiments, apparatus 120 for producing mechanical energy 125 or electricity 126 comprises an internal combustion engine.

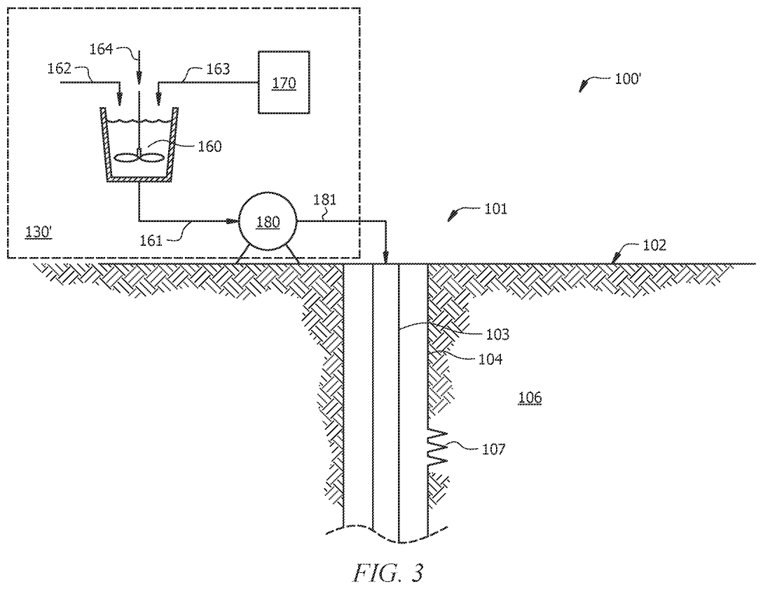

In embodiments, the operation comprises a hydraulic fracturing operation. Such an operation will now be described with reference to FIG. 3, which is a schematic of an example system 100′ for carrying out a hydraulic fracturing operation. In such embodiments, the wellsite apparatus 130 can comprise a hydraulic fracturing system 130′. The hydraulic fracturing system 130′ can comprise blender 160, a proppant system 170, and a pump 180, a or a combination thereof. Blender 160 is configured for producing hydraulic fracturing fluid 161. In embodiments, the hydraulic fracturing fluid 161 comprises water 162, proppant 163, and/or one or more additional components 164. In embodiments, water 162 comprises water 121 produced as a byproduct of producing mechanical energy 125 or electricity 126 in apparatus 120. For example, water 162 can comprise substantially pure water 121 produced in one or more fuel cells of an apparatus 120 that produces electricity 126 for powering one or more components of hydraulic fracturing system 130′. Hydraulic fracturing system 130′ can include a proppant system 170 configured for providing proppant 163. Pump 180 can include one or more above ground (e.g., above surface 102) or downhole (e.g., below surface 102) pumps configured to pump fracturing fluid 180 into formation 106 to produce fractures 107. The fracturing fluid can be pumped downhole via tubing 103 in wellbore 104. Hydraulic fracturing system 130′ can further include apparatus selected from forklifts, cranes, centrifugal pumps, sand-handling equipment, or a combination thereof. Via this disclosure, a wellsite apparatus 130 comprising one or more components of hydraulic fracturing system 130′ (e.g., blender 160, one or more components of proppant system 170 such as a forklift, crane, sand-handling equipment, etc.), one or more pumps (e.g., downhole pumps, centrifugal pumps) of pump 180 are powered by mechanical energy 125 or electricity 126 produced with fuel 114 comprising hydrogen 111. The mechanical energy 125 or electricity 126 can be produced in apparatus 120, as described hereinabove with reference to FIG. 2.

In embodiments, as noted above, the wellsite apparatus 130 can be powered by an electric motor, and apparatus 120 can be or comprise part of a power generation system that produces electricity for the electric motor. In embodiments, the wellsite apparatus 130 can be powered by an internal combustion engine (e.g., in which embodiments, the apparatus 120 can comprise an internal combustion engine).

In embodiments, the mechanical energy 125 or electricity 126 utilized to power the wellsite apparatus 130 of hydraulic fracturing system 130′ is produced without the production of substantial nitrogen or nitrogen oxides (NOx). For example, the wellsite apparatus 130 can be operated with electricity produced via an apparatus 120 comprising one or more fuel cells. In such embodiments. NOx removal apparatus 140 can be absent or reduced in size relative to a conventional system in which hydrogen is not utilized, at least on part, to fuel wellsite apparatus 130.

In embodiments, hydraulic fracturing system 130′ comprises an electric hydraulic fracturing system, and apparatus 120 for producing mechanical energy 125 or electricity 126 is an apparatus 120 for producing, from hydrogen 111 of fuel source 110, electricity 126 for an electrical grid of the electric hydraulic fracturing system 130′.

In embodiments, a system of this disclosure comprises: a hydraulic fracturing apparatus 130′ (e.g., comprising: a downhole pump, a blender, a proppant system, or a combination thereof), wherein the hydraulic fracturing apparatus 130′ is powered, at least in part, by hydrogen 111 as a fuel 110. As noted above, in embodiments, the hydraulic fracturing apparatus comprises an electric-driven hydraulic fracturing apparatus, and the electric-driven hydraulic fracturing apparatus is powered, at least in part, by combustion of hydrogen 111 in a power production apparatus 120 and/or electrochemical conversion of the hydrogen 111 to electricity (e.g., in one or more fuel cells of apparatus 120). In such embodiments, the hydraulic fracturing apparatus 130 can be powered, at least in part, by combustion of the hydrogen 111 in the fuel source 110. The hydraulic fracturing system 100′ can comprise one or more fuel cells (e.g., apparatus 120 comprises one or more fuel cells) for producing electricity 126 from the hydrogen 111 and an oxidant 115, and/or one or more generators (e.g., apparatus 120 comprises one or more turbine generators and/or reciprocating engine generators) for combusting the hydrogen 111 of the fuel source 110.

In embodiments, the operation comprises a pump down operation, and wellsite apparatus 130 comprises a pump down operations apparatus. Such pump down operations apparatus can be, for example and without limitation, selected from pumping units and centrifugal pumps utilized to pump down wireline perforating guns. In embodiments, the pump down operations apparatus comprises an electric-driven pumping unit employed to pump down wireline perforating guns. In embodiments, electricity 126 produced at least in part from the hydrogen 111 in the fuel source 110 comprising hydrogen is utilized to power the electric-driven pumping unit.

In embodiments, the operation comprises a coiled tubing operation and the wellsite apparatus 130 comprises a coiled tubing operations apparatus. By way of non-limiting examples, such coiled tubing operations apparatus 130 can be selected from hydraulic power packs used on coiled tubing units, cranes, and other support equipment. In embodiments, the coiled tubing apparatus comprises an electric-coiled tubing apparatus selected from electric-driven hydraulic power packs used on coiled tubing units, cranes, and other support equipment, and the method comprises utilizing electricity 126 produced at least in part from the hydrogen 111 in the fuel source 110 comprising hydrogen 111 to power the coiled tubing operations apparatus.

In embodiments, the operation comprises a wireline operations apparatus and the wellsite apparatus 130 comprises a wireline operations apparatus. By way of non-limiting examples, such coiled tubing operations apparatus 130 can be selected from wireline hydraulic power packs, winches, cranes, and other systems. In embodiments, the wireline operations apparatus is selected from electric-driven winches, power packs, cranes, and other systems, and the method comprises utilizing electricity 126 produced at least in part from the hydrogen 111 in the fuel source 110 comprising hydrogen 11 to power the wireline operations apparatus 130.

In embodiments, the operation comprises a nitrogen operation and the wellsite apparatus 130 comprises a nitrogen operations apparatus 130. By way of non-limiting examples, such nitrogen operations apparatus 130 can be selected from pumping units and evaporators. In embodiments, the nitrogen operations apparatus is selected from electric-driven nitrogen pumping units and evaporators, and the method comprises utilizing electricity 126 produced at least in part from the hydrogen 111 in the fuel source 110 comprising hydrogen 111 to power the nitrogen operations apparatus 130.

In embodiments, the operation comprises an ancillary support operation, and the wellsite apparatus 130 comprises an ancillary support operations apparatus 130. By way of non-limiting examples, such ancillary support operations apparatus 130 can be selected from engines on rig heaters, light plants, water transfer operation apparatus, tele-handlers, and apparatus for carrying out other support functions. In embodiments, the ancillary support operations apparatus is selected from electric-driven heaters, light stands, electric water transfer pumps, electric tele-handlers, and apparatus for carrying out another support function, and the method comprises utilizing electricity 126 produced at least in part from the hydrogen 111 in the fuel source 110 comprising hydrogen 111 to power the ancillary support operations apparatus.

In embodiments, the operation comprises a production operation and the wellsite apparatus 130 comprises a production operations apparatus 130. By way of non-limiting examples, such production operations apparatus 130 can be selected from pumps, such as, without limitation, fluid injection pumps, gas compression pumps, etc. In embodiments, the production operations apparatus 130 is selected from electric-driven pumps for fluid injection in disposal wells, pressure-maintenance wells, EOR applications, and/or for operating pump jacks, and the method comprises utilizing electricity 126 produced at least in part from the hydrogen 111 in the fuel source 110 comprising hydrogen 111 to power the production operations apparatus 130.

In embodiments, the operation comprises a trucking/transport operation and the wellsite apparatus 130 comprises a trucking/transport operations apparatus 130. By way of non-limiting examples, such trucking/transport operations apparatus 130 can be selected from vehicles utilized on the wellsite, such as, without limitation, 18-wheelers, etc. In embodiments, the trucking/transport operations apparatus is selected from electric-driven vehicles, and the method comprises utilizing electricity 126 produced at least in part from the hydrogen 111 in the fuel source 110 comprising hydrogen 111 to power the trucking/transport operations apparatus 130.

In embodiments, the operation comprises a power generation operation and the wellsite apparatus 130 comprises a power generation operation apparatus 130, such as, without limitation, an engine on a genset providing electricity 126 on the wellsite 101. As utilized herein a genset is an engine generator comprising an electrical generator and an engine mounted together (e.g., to form a single piece of equipment). A genset is also referred herein as an engine-generator or a “genset”, or simply a generator. In embodiments, the apparatus 120 for producing mechanical energy 125 or electricity 126 and the wellsite apparatus 130 can be the same apparatus (e.g., an engine on a genset, or fuel cell). By way of non-limiting examples, such power generation operations apparatus 130 can be selected from, the power generation apparatus 120/130 comprises a fuel cell providing electricity on the wellsite 101, and the method comprises utilizing the electricity 126 produced at least in part from the hydrogen 111 in the fuel source 110 comprising hydrogen 111 on the wellsite 101.

In embodiments, the operation comprises an acidizing operation and the wellsite apparatus 130 comprises an acidizing operations apparatus 130. By way of non-limiting examples, such acidizing operations apparatus 130 can be selected from pumping units and blenders. In embodiments, the acidizing operations apparatus 130 is selected from electric-driven pumping units and blenders, and the method comprises utilizing electricity 126 produced at least in part from the hydrogen 111 in the fuel source 110 comprising hydrogen 111 to power the acidizing operations apparatus 130.

In embodiments, the operation comprises a drilling operation and the wellsite apparatus 130 comprises a drilling operations apparatus 130. By way of non-limiting examples, such drilling operations apparatus 130 can be selected from draw works, rotary table drives, top drives, automated tubing handlers, mud pumps, shale shakers, etc. In embodiments, the drilling operations apparatus comprises an electric-driven apparatus, such as electric-driven draw works, rotary table drives, top drives, automated tubing handlers, mud pumps, shale shakers, etc., and the method comprises utilizing electricity 126 produced at least in part from the hydrogen 111 in the fuel source 110 comprising hydrogen 111 to power the drilling operations apparatus 130.

In embodiments, the operation comprises a pipeline services operation and the wellsite apparatus 130 comprises a pipeline services apparatus 130. By way of non-limiting examples, such pipeline services apparatus 130 can be selected from mixing systems, single- and multistage-centrifugal pumps, positive displacement pumps, separation equipment, etc. In embodiments, the pipeline services apparatus 130 comprises an electric-driven pipeline services operation apparatus 130, such as electric-driven inspection equipment, mixing systems, single- and multistage-centrifugal pumps, positive displacement pumps, separation equipment, etc., and the method comprises utilizing electricity 126 produced at least in part from the hydrogen 111 in the fuel source 110 comprising hydrogen 111 to power the pipeline services operation apparatus 130.

The apparatuses, systems, and methods disclosed herein may be employed in the context of various wellbore servicing systems and methodologies, examples of which are disclosed in U.S. Pat. No. 7,841,394. U.S. Pat. No. 8,834,012. U.S. Pat. Nos. 11,377,943, and 11,421,673, the disclosure of each of which is hereby incorporated herein by reference in its entirety for purposes not contrary to this disclosure.

A benefit of utilizing hydrogen as a fuel as described herein can be that such utilization can results in a near zero carbon-product gas emissions 155 from the wellsite 101. In embodiments, hydrogen 111 is sourced from renewable power, otherwise known as “green H₂”, or other net negative carbon based energy conversions, such that the production, distribution, and transportation of the hydrogen does not produce undesirable carbon product gas emissions. Accordingly, in embodiments, green H₂ is utilized to source the hydrogen 111 of the fuel source 110 comprising hydrogen.

With environmental, social, and governance (ESG) based investment metrics and greenhouse gas (GHG) based operational regulations, the use of hydrogen 111 as a fuel 114 to power a wellsite apparatus 130, as described hereinabove, can significantly attract investment and enhance freedom to operate.

Other advantages will be apparent to those of skill in the art and with the help of this disclosure.

### Examples

The embodiments having been generally described, the following examples are given as particular examples to demonstrate the practice and advantages of this disclosure. It is understood that the examples are given by way of illustration and are not intended to limit the specification or the claims in any manner.

In this example, hydrogen can be utilized for power generation. For example, a trailer can be employed to carry a number of fuel cells. The fuel cells can utilize hydrogen as a fuel source which combines with atmospheric air to produce DC electricity. The fuel cells can be stacked (e.g., placed in series electrically) to produce a desired DC voltage, for example, 700 VDC. The DC voltage can then be utilized directly for loads or converted to AC voltage, for example 480 VAC, with an inverter. The AC voltage can then be utilized for loads or transformed to a desired voltage, for example 13.8kVAC, which can then be utilized by various loads.

Additional Disclosure

The following are non-limiting, specific embodiments in accordance with the present disclosure:

In a first embodiment, a method comprises: operating a wellsite apparatus at a wellsite utilizing mechanical energy or electricity produced at least in part from hydrogen in a fuel source comprising hydrogen.

A second embodiment can include the method of the first embodiment, wherein utilizing mechanical energy or electricity produced at least in part from the hydrogen in the fuel source comprising hydrogen further comprises: (a) converting the hydrogen in the fuel source to electricity in one or more fuel cells and utilizing the electricity to operate the wellsite apparatus; and/or (b) combusting the hydrogen in the fuel source in a power generation apparatus to produce electricity and utilizing the electricity to operate the wellsite apparatus; and/or (c) combusting the hydrogen in the fuel source to produce mechanical energy and utilizing the mechanical energy to operate the wellsite apparatus.

A third embodiment can include the method of the second embodiment, comprising (b) an/or (c), and further comprising removing nitrogen oxides (NOx) from an exhaust produced by the combusting of the hydrogen in the fuel source.

A fourth embodiment can include the method of the third embodiment, wherein the combusting is effected in a turbine generator and/or a reciprocating engine generator.

A fifth embodiment can include the method of any one of the second to fourth embodiments, comprising (a), wherein the one or more fuel cells are located at the wellsite or another location.

A sixth embodiment can include the method of any one of the second to fifth embodiments, comprising (a), and further comprising utilizing an inverter to provide AC for the wellsite apparatus.

A seventh embodiment can include the method of the sixth embodiment, wherein the wellsite apparatus comprises an AC motor.

An eighth embodiment can include the method of any one of the second to seventh embodiments, comprising (a), wherein substantially pure water and heat are byproducts of converting the hydrogen in the fuel source to electricity in the one or more fuel cells, and wherein the method further comprises utilizing the substantially pure water and/or the heat at the wellsite.

A ninth embodiment can include the method of the eighth embodiment, wherein utilizing the substantially pure water at the wellsite comprises utilizing the substantially pure water to produce a fracturing fluid.

A tenth embodiment can include the method of any one of the first to ninth embodiments, further comprising producing at least a portion of the hydrogen in the fuel source at the wellsite or another location.

An eleventh embodiment can include the method of the tenth embodiment, wherein utilizing mechanical energy or electricity produced at least in part from hydrogen in the fuel source comprising hydrogen comprises utilizing electricity produced at least in part from hydrogen in the fuel source comprising hydrogen, and further comprising producing the electricity at the another location and routing it to the wellsite.

A twelfth embodiment can include the method of any one of the first to eleventh embodiments, wherein the wellsite apparatus is a component of an electric hydraulic fracturing system at the wellsite.

A thirteenth embodiment can include the method of any one of the first to twelfth embodiments, wherein the wellsite produces less than or equal to about 150 tons/day of carbon dioxide (CO₂) emissions.

A fourteenth embodiment can include the method of any one of the first to thirteenth embodiments, wherein the fuel source comprises a dual fuel comprising the hydrogen and another fuel, or wherein the fuel comprises a tri-fuel comprising the hydrogen and two other fuels.

A fifteenth embodiment can include the method of the fourteenth embodiment, wherein the another fuel comprises methane or diesel, or wherein the two other fuels comprise methane and diesel.

A sixteenth embodiment can include the method of any one of the first to fifteenth embodiments, wherein the wellsite apparatus comprises a fracturing (e.g., hydraulic fracturing) apparatus.

A seventeenth embodiment can include the method of any one of the first to sixteenth embodiments, wherein the mechanical energy or electricity is produced without the production of substantial nitrogen oxides (NOx).

An eighteenth embodiment can include the method of any one of the first to seventeenth embodiments, wherein the wellsite apparatus comprises a hydraulic fracturing apparatus selected from downhole pumping units, blenders, forklifts, cranes, centrifugal pumps, sand-handling equipment, or a combination thereof.

A nineteenth embodiment can include the method of the eighteenth embodiment, wherein the hydraulic fracturing apparatus comprises an electric fracturing apparatus, and wherein the method comprises utilizing electricity produced at least in part from the hydrogen in the fuel source comprising hydrogen.

A twentieth embodiment can include the method of any one of the first to nineteenth embodiments, wherein the wellsite apparatus comprises a pump down operations apparatus selected from pumping units and centrifugal pumps utilized to pump down wireline perforating guns.

A twenty first embodiment can include the method of the twentieth embodiment, wherein the pump down apparatus comprises an electric-driven pumping unit used to pump down the wireline perforating guns, and wherein the method comprises utilizing electricity produced at least in part from the hydrogen in the fuel source comprising hydrogen.

A twenty second embodiment can include the method of any one of the first to twenty first embodiments, wherein the wellsite apparatus comprises a coiled tubing operations apparatus selected from hydraulic power packs used on coiled tubing units, cranes, and other support equipment.

A twenty third embodiment can include the method of the twenty second embodiment, wherein the coiled tubing apparatus comprises an electric-coiled tubing apparatus selected from electric-driven hydraulic power packs used on coiled tubing units, cranes, and other support equipment, and wherein the method comprises utilizing electricity produced at least in part from the hydrogen in the fuel source comprising hydrogen.

A twenty fourth embodiment can include the method of any one of the first to twenty third embodiments, wherein the wellsite apparatus comprises a wireline operations apparatus selected from wireline hydraulic power packs, winches, cranes, and other systems.

A twenty fifth embodiment can include the method of the twenty fourth embodiment, wherein the wireline operations apparatus is selected from electric-driven winches, power packs, cranes, and other systems, and wherein the method comprises utilizing electricity produced at least in part from the hydrogen in the fuel source comprising hydrogen.

A twenty sixth embodiment can include the method of any one of the first to twenty fifth embodiments, wherein the wellsite apparatus comprises a nitrogen operations apparatus selected from pumping units and evaporators.

A twenty seventh embodiment can include the method of the twenty sixth embodiment, wherein the nitrogen operations apparatus is selected from electric-driven nitrogen pumping units and evaporators, and wherein the method comprises utilizing electricity produced at least in part from the hydrogen in the fuel source comprising hydrogen.

A twenty eighth embodiment can include the method of any one of the first to twenty seventh embodiments, wherein the wellsite apparatus comprises an ancillary support operations apparatus selected from engines on rig heaters, light plants, water transfer apparatus, tele-handlers, and other support apparatus.

A twenty ninth embodiment can include the method of the twenty eighth embodiment, wherein the ancillary support operations apparatus is selected from electric-driven heaters, light stands, electric water transfer pumps, electric tele-handlers, and other support apparatus, and wherein the method comprises utilizing electricity produced at least in part from the hydrogen in the fuel source comprising hydrogen.

A thirtieth embodiment can include the method of any one of the first to twenty ninth embodiments, wherein the wellsite apparatus comprises a production operations apparatus selected from pumps, such as, without limitation, fluid injection pumps, gas compression pumps, etc.

A thirty first embodiment can include the method of the thirtieth embodiment, wherein the production operations apparatus is selected from electric-driven pumps for fluid injection in disposal wells, pressure-maintenance wells. FOR applications, and/or for operating pump jacks, and wherein the method comprises utilizing electricity produced at least in part from the hydrogen in the fuel source comprising hydrogen.

A thirty second embodiment can include the method of any one of the first to thirty first embodiments, wherein the wellsite apparatus comprises a trucking operations apparatus selected from vehicles utilized on the wellsite, such as, without limitation. 18-wheelers, etc.

A thirty third embodiment can include the method of the thirty second embodiment, wherein the trucking operations apparatus is selected from electric-driven vehicles, and wherein the method comprises utilizing electricity produced at least in part from the hydrogen in the fuel source comprising hydrogen.

A thirty fourth embodiment can include the method of any one of the first to thirty third embodiments, wherein the wellsite apparatus comprises a power generation apparatus, such as, without limitation, an engine on a genset providing electricity on the wellsite.

A thirty fifth embodiment can include the method of the thirty fourth embodiment, wherein the power generation apparatus comprises a fuel cell providing electricity on the wellsite, and wherein the method comprises utilizing the electricity produced at least in part from the hydrogen in the fuel source comprising hydrogen.

A thirty sixth embodiment can include the method of any one of the first to thirty fifth embodiment, wherein the wellsite apparatus comprises an acidizing operations apparatus, such as, without limitation, an acidizing operations apparatus selected from pumping units and blenders.

A thirty seventh embodiment can include the method of the thirty sixth embodiment, wherein the acidizing operations apparatus is selected from electric-driven pumping units and blenders, and wherein the method comprises utilizing electricity produced at least in part from the hydrogen in the fuel source comprising hydrogen.

A thirty eighth embodiment can include the method of any one of the first to thirty seventh embodiments, wherein the wellsite apparatus comprises a drilling operations apparatus, such as, without limitation, a drilling operations apparatus selected from draw works, rotary table drives, top drives, automated tubing handlers, mud pumps, shale shakers, etc.

A thirty ninth embodiment can include the method of the thirty eighth embodiment, wherein the drilling operations apparatus is selected from electric-driven draw works, rotary table drives, top drives, automated tubing handlers, mud pumps, shale shakers, etc., and wherein the method comprises utilizing electricity produced at least in part from the hydrogen in the fuel source comprising hydrogen.

A fortieth embodiment can include the method of any one of the first to thirty ninth embodiments, wherein the wellsite apparatus comprises a pipeline services apparatus, such as, without limitation mixing systems, single- and multistage-centrifugal pumps, positive displacement pumps, separation equipment, etc.

A forty first embodiment can include the method of the fortieth embodiment, wherein the pipeline services apparatus is selected from electric-driven inspection equipment, mixing systems, single- and multistage-centrifugal pumps, positive displacement pumps, separation equipment, etc., and wherein the method comprises utilizing electricity produced at least in part from the hydrogen in the fuel source comprising hydrogen.

In a forty second embodiment, a method of performing an operation at a wellsite comprises: utilizing hydrogen as a fuel source for a prime mover for powering a wellsite apparatus, wherein the wellsite apparatus is utilized in performing the operation at the wellsite.

A forty third embodiment can include the method of the forty second embodiment, wherein the operation is selected from hydraulic fracturing operations, pump down operations, coiled tubing operations, wireline operations, nitrogen operations, ancillary support operations, production operations, transporting (e.g., trucking) operations, power generation operations, acidizing operations, drilling operations, pipeline servicing operations, or combinations thereof.

A forty fourth embodiment can include the method of any one of the forty second or forty third embodiments, wherein the wellsite apparatus is electric-driven (e.g., comprises an electric motor), and wherein the prime mover is part of a power (e.g., electricity) generation system.

A forty fifth embodiment can include the method of the forty fourth embodiment, wherein the prime mover comprises one or more fuel cells.

A forty sixth embodiment can include the method of any one of the forty second to forty fifth embodiments, wherein the prime mover comprises hydrogen combustion apparatus.

A forty seventh embodiment can include the method of any one of the forty second to forty sixth embodiments, wherein the prime mover comprises an internal combustion engine.

A forty eighth embodiment can include the method of any one of the forty second to forty seventh embodiments, wherein the operation comprises a hydraulic fracturing operation.

A forty ninth embodiment can include the method of the forty eighth embodiment, wherein the wellsite apparatus comprises a pump, a blender, a proppant system, or a combination thereof.

A fiftieth embodiment can include the method of any one of the forty eighth to forty ninth embodiments, wherein the wellsite apparatus is powered by an electric motor, and wherein the prime mover is part of a power generation system that produces electricity for the electric motor.

A fifty first embodiment can include the method of any one of the forty eighth to fiftieth embodiments, wherein the wellsite apparatus is powered by an internal combustion engine (e.g., wherein the prime mover comprises an internal combustion engine).

In a fifty second embodiment, a system for carrying out an operation at a wellsite comprises: a wellsite apparatus at a wellsite; and a prime mover configured to power the wellsite apparatus, wherein the prime mover is operable to produce mechanical energy or electricity for powering the wellsite apparatus, wherein the mechanical energy or electricity is produced at least in part from hydrogen in a fuel source comprising hydrogen.

A fifty third embodiment can include the system of the fifty second embodiment, wherein the operation is selected from hydraulic fracturing operations, pump down operations, coiled tubing operations, wireline operations, nitrogen operations, ancillary support operations, production operations, transporting (e.g., trucking) operations, power generation operations, acidizing operations, drilling operations, pipeline servicing operations, or combinations thereof.

A fifty fourth embodiment can include the system of any one of the fifty second to fifty third embodiments, wherein the wellsite apparatus is electric-driven (e.g., comprises an electric motor), and wherein the prime mover is part of a power (e.g., electricity) generation system.

A fifty fifth embodiment can include the system of the fifty fourth embodiment, wherein the prime mover comprises one or more fuel cells.

A fifty sixth embodiment can include the system of any one of the fifty second to fifty fifth embodiments, wherein the prime mover comprises hydrogen combustion apparatus.

A fifty seventh embodiment can include the system of any one of the fifty second to fifty sixth embodiments, wherein the prime mover comprises an internal combustion engine.

A fifty eighth embodiment can include the system of any one of the fifty second to fifty seventh embodiments, wherein the operation comprises a hydraulic fracturing operation.

A fifty ninth embodiment can include the system of the fifty eighth embodiment, wherein the wellsite apparatus comprises a pump, a blender, a proppant system, or a combination thereof.

A sixtieth embodiment can include the system of any one of the fifty eighth to fifty ninth embodiments, wherein the wellsite apparatus is powered by an electric motor, and wherein the prime mover is part of a power generation system that produces electricity for the electric motor.

A sixty first embodiment can include the system of any one of the fifty eighth to sixtieth embodiments, wherein the wellsite apparatus is powered by an internal combustion engine (e.g., wherein the prime mover comprises an internal combustion engine).

In a sixty second embodiment, a system comprises: a hydraulic fracturing apparatus comprising: a downhole pump, a blender, a proppant system, or a combination thereof, wherein the hydraulic fracturing apparatus is powered, at least in part, by hydrogen as a fuel.

In a sixty third embodiment, a system comprises the system of the sixty second embodiment, wherein the hydraulic fracturing apparatus comprises an electric-driven hydraulic fracturing apparatus, and wherein the electric-driven hydraulic fracturing apparatus is powered, at least in part, by combustion of the hydrogen in a power production apparatus and/or electrochemical conversion of the hydrogen to electricity (e.g., in one or more fuel cells).

In a sixty fourth embodiment, a system comprises the system of any one of the sixty second to sixty third embodiments, wherein the hydraulic fracturing apparatus is powered, at least in part, by combustion of the hydrogen.

In a sixty fifth embodiment, a system comprises the system of any one of the sixty second to sixty fourth embodiments further comprising one or more fuel cells for producing electricity from the hydrogen and an oxidant, and/or one or more generators (e.g., turbine generators and/or reciprocating engine generators) for combusting the hydrogen.

While embodiments have been shown and described, modifications thereof can be made by one skilled in the art without departing from the spirit and teachings of this disclosure. The embodiments described herein are exemplary only, and are not intended to be limiting. Many variations and modifications of the embodiments disclosed herein are possible and are within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit. RI, and an upper limit, Ru, is disclosed, any number falling within the range is specifically disclosed. In particular, the following numbers within the range are specifically disclosed: R=RI+k*(Ru-RI), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . 95 percent, 96 percent, 97 percent, 98 percent. 99 percent, or 100 percent. Moreover, any numerical range defined by two R numbers as defined in the above is also specifically disclosed. Use of broader terms such as comprises, includes, having, etc. should be understood to provide support for narrower terms such as consisting of, consisting essentially of, comprised substantially of, etc. When a feature is described as “optional,” both embodiments with this feature and embodiments without this feature are disclosed. Similarly, the present disclosure contemplates embodiments where this “optional” feature is required and embodiments where this feature is specifically excluded.

Accordingly, the scope of protection is not limited by the description set out above but is only limited by the claims which follow, that scope including all equivalents of the subject matter of the claims. Each and every claim is incorporated into the specification as embodiments of the present disclosure. Thus, the claims are a further description and are an addition to the embodiments of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

What is claimed is:

1. A method comprising:
operating a wellsite apparatus at a wellsite utilizing mechanical energy or electricity produced at least in part from hydrogen in a fuel source comprising hydrogen.

2. The method of claim 1, wherein utilizing mechanical energy or electricity produced at least in part from the hydrogen in the fuel source comprising hydrogen further comprises:
(a) converting the hydrogen in the fuel source to electricity in one or more fuel cells and utilizing the electricity to operate the wellsite apparatus; and/or
(b) combusting the hydrogen in the fuel source in a power generation apparatus to produce electricity and utilizing the electricity to operate the wellsite apparatus; and/or
(c) combusting the hydrogen in the fuel source to produce mechanical energy and utilizing the mechanical energy to operate the wellsite apparatus.

3. The method of claim 2, comprising (b) an/or (c), and further comprising removing nitrogen oxides (NOx) from an exhaust produced by the combusting of the hydrogen in the fuel source.

4. The method of claim 2 comprising (a), and further comprising utilizing an inverter to provide AC for the wellsite apparatus.

5. The method of claim 2, comprising (a), wherein substantially pure water and heat are byproducts of converting the hydrogen in the fuel source to electricity in the one or more fuel cells, and wherein the method further comprises utilizing the substantially pure water and/or the heat at the wellsite.

6. The method of claim 1 further comprising producing at least a portion of the hydrogen in the fuel source at the wellsite or another location.

7. The method of claim 1, wherein the wellsite apparatus is a component of an electric hydraulic fracturing system at the wellsite.

8. The method of claim 1, wherein the wellsite apparatus comprises a fracturing apparatus.

9. A method of performing an operation at a wellsite, the method comprising:
utilizing hydrogen as a fuel source for a prime mover for powering a wellsite apparatus, wherein the wellsite apparatus is utilized in performing the operation at the wellsite.

10. The method of claim 9, wherein the operation is selected from hydraulic fracturing operations, pump down operations, coiled tubing operations, wireline operations, nitrogen operations, ancillary support operations, production operations, transporting operations, power generation operations, acidizing operations, drilling operations, pipeline servicing operations, or combinations thereof.

11. The method of claim 9, wherein the wellsite apparatus is electric-driven, and wherein the prime mover is part of a power generation system.

12. The method of claim 9, wherein the operation comprises a hydraulic fracturing operation.

13. A system for carrying out an operation at a wellsite, the system comprising:
a wellsite apparatus at a wellsite; and
a prime mover configured to power the wellsite apparatus, wherein the prime mover is operable to produce mechanical energy or electricity for powering the wellsite apparatus, wherein the mechanical energy or electricity is produced at least in part from hydrogen in a fuel source comprising hydrogen.

14. The system of claim 13, wherein the operation is selected from hydraulic fracturing operations, pump down operations, coiled tubing operations, wireline operations, nitrogen operations, ancillary support operations, production operations, transporting operations, power generation operations, acidizing operations, drilling operations, pipeline servicing operations, or combinations thereof.

15. The system of claim 13, wherein the wellsite apparatus is electric-driven, and wherein the prime mover is part of a power generation system.

16. The system of claim 13, wherein the operation comprises a hydraulic fracturing operation.

17. The system of claim 13, wherein:
the wellsite apparatus comprises a hydraulic fracturing apparatus comprising: a downhole pump, a blender, a proppant system, or a combination thereof, and
wherein the hydraulic fracturing apparatus is powered, at least in part, by hydrogen as the fuel.

18. The system of claim 17, wherein the hydraulic fracturing apparatus comprises an electric-driven hydraulic fracturing apparatus, and wherein the electric-driven hydraulic fracturing apparatus is powered, at least in part, by combustion of the hydrogen in a power production apparatus and/or electrochemical conversion of the hydrogen to electricity.

19. The system of claim 17, wherein the hydraulic fracturing apparatus is powered, at least in part, by combustion of the hydrogen.

20. The system of claim 17 further comprising one or more fuel cells for producing electricity from the hydrogen and an oxidant, and/or one or more generators for combusting the hydrogen.
